(19) United States
(12) Patent Application Publication
(10) Pub. No.: US 2023/0104439 A1
(43) Pub. Date: Apr. 6, 2023

(54) LIGHT SOURCE MODULE AND LIGHTING CIRCUIT

(71) Applicant: KOITO MANUFACTURING CO., LTD., Tokyo (JP)

(72) Inventors: Tomoyuki ICHIKAWA, Shizuoka-shi (JP); Ryota FUWA, Shizuoka-shi (JP); Atsushi OZAWA, Shizuoka-shi (JP)

(73) Assignee: KOITO MANUFACTURING CO., LTD., Tokyo (JP)

(21) Appl. No.: 18/063,792

(22) Filed: Dec. 9, 2022

Related U.S. Application Data
(63) Continuation of application No. PCT/JP2021/021724, filed on Jun. 8, 2021.

(30) Foreign Application Priority Data
Jun. 12, 2020 (JP) 2020-102588

(51) Int. Cl. H05B 45/48; H05B 45/54

(52) U.S. Cl. CPC H05B 45/48; H05B 45/54

(57) ABSTRACT

An LED string includes a plurality of LEDs connected in series, and is divided into a first portion, a second portion, and a third portion. An LED driver circuit receives a power supply voltage according to a battery voltage, and supplies a drive current stabilized at a target current to the LED string. A first bypass circuit is provided in parallel to the first portion and generates a bypass current having a current amount according to the power supply voltage. A second bypass circuit includes a bypass switch provided in parallel to the first portion and the second portion.

### BACKGROUND

### 1. Technical Field

The present disclosure relates to a lamp used for a vehicle such as an automobile.

### 2. Description of the Related Art

Conventionally, a light bulb has been often used as a light source used for a vehicle lamp, but in recent years, a semiconductor light source such as a light emitting diode (LED) has been widely adopted.

FIG. 1 is a block diagram of a conventional vehicle lamp 1. The vehicle lamp 1 receives a DC voltage (input voltage V_{IN}) from a battery 2 via a switch 4. An LED string (LED bar) 10 includes a plurality of n LEDs 12 connected in series. The luminance of the LED string 10 is controlled according to a drive current I_{LED} flowing therethrough. A lighting circuit 20 includes an LED driver circuit 22 that stabilizes the drive current I_{LED} to a target amount I_{REF} according to a target luminance.

When a forward voltage while the drive current I_{LED} stabilized at the target amount I_{REF} is flowing through the LED 12 is assumed to be Vf₀, a voltage V_{MIN} across the LED string 10 (referred to as a minimum lighting voltage) is Vf₀×n. When n=3, V_{MIN} is nearly equal to 11 V in a white LED. In other words, when an output voltage V_{OUT} of the LED driver circuit 22 falls below the minimum lighting voltage V_{MIN}, the drive current I_{LED} cannot maintain the target amount I_{REF}, and the plurality of LEDs 12 are unlit.

In an LED socket sold as an alternative to a conventional automotive light bulb, cost reduction is required, and therefore, the LED driver circuit 22 is configured by a constant-current series regulator, a step-down converter with constant-current output, or a resistor. In this case, the output voltage V_{OUT} of the LED driver circuit 22 is lower than the input voltage V_{IN}. The input voltage V_{IN} is 13 V in a fully charged state of the battery, but it is not uncommon that the input voltage V_{IN} decreases to 10 V or less as discharging progresses. In particular, in an idling-stop vehicle, when the engine is stopped during stoppage and then the engine is restarted, the input voltage V_{IN} may be lowered to around 6 V, and therefore, the vehicle lamp may be required to keep lighting at 6 V. Therefore, when the battery voltage V_{BAT} decreases (referred to as a low voltage state), a situation in which the output voltage V_{OUT} falls below the minimum lighting voltage V_{MIN} occurs, and the LED 12 is unlit.

A bypass switch 24 and a bypass control circuit 26 are provided to prevent the LED strings 10 from being unlit in the low voltage state. The bypass switch 24 is connected in parallel to one LED 12_n on the lowest potential side. When the input voltage V_{IN} becomes lower than a certain threshold value V_{TH}, the bypass control circuit 26 determines a low voltage state and turns on the bypass switch 24. In this state, the minimum lighting voltage V_{MIN}=Vf₀×(n−1), and V_{IN}>V_{MIN} is maintained. That is, in exchange for the unlit state of the LED 12_n, the lighting of the remaining LEDs 12_1 to 12_(n−1) can be maintained.

FIG. 2 is a circuit diagram illustrating a lighting circuit of a white LED. In many cases, white LEDs are designed with n=3. The white LEDs may be structured as a combination of blue LEDs and a phosphor for color conversion. The forward voltage of a diode 30 for preventing reverse connection is estimated to be 1 V at most, and the forward voltage of a single LED is estimated to be 3.3 V at most. In this case, in order to maintain lighting in a low voltage state where the input voltage V_{IN} is 6 V, the bypass switch 24 needs to be connected in parallel to the two LEDs 12_2 and 12_3.

FIG. 3A is a diagram for explaining an operation of the lighting circuit of FIG. 2. The threshold value V_{TH} is set to be higher than 1+3.3×3=10.9 V (for example, 11 V), and the bypass switch 24 is turned on before the input voltage V_{IN} decreases to 10.9 V. As a result, even if the input voltage V_{IN} decreases to 6 V, it is possible to maintain the lighting of one LED 12_1. However, there is a problem in that the light amount is reduced to ⅓ even in a voltage range in which the two LEDs can be lit. In addition, since the light amount changes to ⅓ (three times) with the threshold value V_{TH} as a boundary, flickering may be a problem.

It is also possible to conceive a configuration in which the bypass switch 24 is replaced with a bypass circuit having a current source and the current of the current source is increased as the input voltage V_{IN} decreases. FIG. 3B is a diagram for explaining an operation of the lighting circuit including the bypass circuit having the current source. In this case, the light amount gradually changes depending on the input voltage V_{IN}, but since the light amount changes to ⅓ (three times) in a narrow voltage range, flickering also becomes a problem. Also, even in a voltage range in which the two LEDs can be lit, the problem that the light amount is reduced to ⅓ cannot be solved.

Note that, although an example of n=3 has been described here, a similar problem may occur in a lamp with n=4.

### SUMMARY

The present disclosure has been made in view of such a problem, and an exemplary object of an aspect of the present disclosure is to provide a vehicle lamp that suppresses flickering while maintaining lighting in a low voltage state.

One aspect of the present disclosure relates to a light source module. The light source module includes: an LED string that includes a plurality of light emitting diodes (LEDs) connected in series and that is divided into a first portion, a second portion, and a third portion; an LED driver circuit that receives a power supply voltage based on a battery voltage and supplies a drive current stabilized at a target current to the LED string; a first bypass circuit that is provided in parallel to the first portion and generates a bypass current with a current amount according to the power supply voltage; and a second bypass circuit that includes a bypass switch provided in parallel to the first portion and the second portion.

Another aspect of the present disclosure also relates to a light source module. The light source module includes: an LED string that includes a plurality of light emitting diodes (LEDs) connected in series and that is divided into a first portion, a second portion, and a third portion; an LED driver circuit that receives a power supply voltage according to a battery voltage and supplies a drive current stabilized at a target current to the LED string; a first bypass circuit that is provided in parallel to the first portion and generates a bypass current according to the power supply voltage; and a second bypass circuit that includes a bypass switch provided in parallel to the second portion.

Another aspect of the present disclosure relates to a lighting circuit. The lighting circuit drives an LED string that includes a plurality of light emitting diodes (LEDs) connected in series and that is divided into a first portion, a second portion, and a third portion. The lighting circuit includes: an LED driver circuit that receives a power supply voltage according to a battery voltage and supplies a drive current stabilized at a target current to the LED string; a first bypass circuit that is provided in parallel to the first portion and generates a bypass current with a current amount according to the power supply voltage; and a second bypass circuit that includes a bypass switch provided in parallel to the first portion and the second portion.

Another aspect of the present disclosure also relates to a lighting circuit. The lighting circuit drives an LED string that includes a plurality of light emitting diodes (LEDs) connected in series and that is divided into a first portion, a second portion, and a third portion. The lighting circuit includes: an LED driver circuit that receives a power supply voltage according to a battery voltage and supplies a drive current stabilized at a target current to the LED string; a first bypass circuit that is provided in parallel to the first portion and generates a bypass current according to the power supply voltage; and a second bypass circuit that includes a bypass switch provided in parallel to the second portion.

It is to be noted that any arbitrary combination or rearrangement of the above-described structural components and so forth is effective as and encompassed by the present embodiments. Moreover, this summary does not necessarily describe all necessary features so that the disclosure may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram of a conventional vehicle lamp;

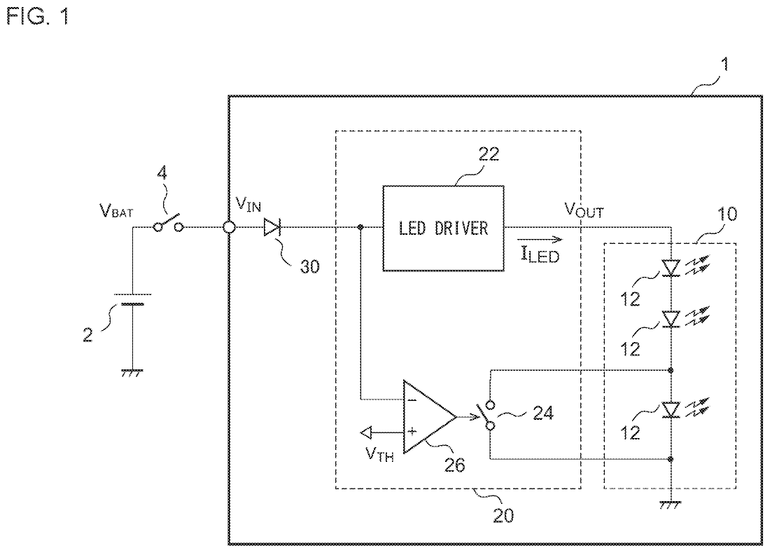

FIG. 2 is a circuit diagram illustrating a lighting circuit of a white LED;

FIG. 3A is a diagram for explaining an operation of the lighting circuit of FIG. 2, and FIG. 3B is a diagram for explaining an operation of the lighting circuit including a bypass circuit having a current source;

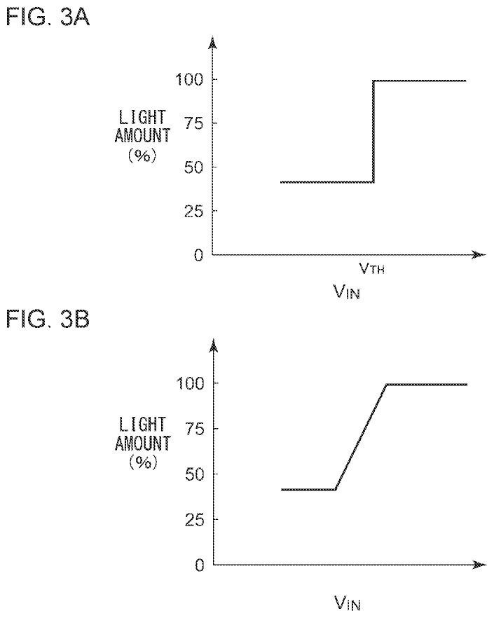

FIG. 4 is a block diagram of a light source module including a lighting circuit according to an embodiment;

FIG. 5 is a diagram for explaining an operation of the light source module of FIG. 4;

FIG. 6 is a circuit diagram of a light source module according to a comparative technique;

FIGS. 7A to 7D are circuit diagrams illustrating a configuration example of a second bypass circuit.

FIG. 8 is a diagram for explaining an operation when a third voltage has hysteresis;

FIGS. 9A and 9B are circuit diagrams illustrating a configuration example of a first bypass circuit;

FIG. 10 is a circuit diagram of a light source module according to a first modification example; and

FIGS. 11A to 11C are diagrams for explaining a light source module according to a second modification example.

### DETAILED DESCRIPTION

### Summary of Embodiments

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “one embodiment” may be used herein to refer to a single embodiment or multiple embodiments of the disclosure.

A light source module according to one embodiment includes: an LED string that includes a plurality of light emitting diodes (LEDs) connected in series and that is divided into a first portion, a second portion, and a third portion; an LED driver circuit that receives a power supply voltage based on a battery voltage and supplies a drive current stabilized at a target current to the LED string; a first bypass circuit that is provided in parallel to the first portion and generates a bypass current with a current amount according to the power supply voltage; and a second bypass circuit that includes a bypass switch provided in parallel to the first portion and the second portion.

A light source module according to one embodiment includes: an LED string that includes a plurality of light emitting diodes (LEDs) connected in series and that is divided into a first portion, a second portion, and a third portion; an LED driver circuit that receives a power supply voltage according to a battery voltage and supplies a drive current stabilized at a target current to the LED string; a first bypass circuit that is provided in parallel to the first portion and generates a bypass current according to the power supply voltage; and a second bypass circuit that includes a bypass switch provided in parallel to the second portion.

With these configurations, as the bypass current increases with a decrease in the battery voltage, the luminance of the first portion gradually decreases to zero, and the state can be gradually shifted to a state in which only the second portion and the third portion are lit, whereby flickering can be suppressed. Furthermore, it is possible to maintain lighting at two portions, i.e., the second portion and the third portion, and thus, it is possible to suppress a significant decrease in the light amount. When the battery voltage further decreases, the second portion can be unlit and only the third portion can be lit by turning on the bypass switch. As a result, the lighting state can be maintained even at a low voltage of about 6 V.

In one embodiment, the bypass current may be zero in a range where the power supply voltage is higher than a first voltage, and start to increase when the power supply voltage falls below the first voltage, and increase to the target current when the power supply voltage decreases to a second voltage. The second bypass circuit may turn on the bypass switch in a range where the power supply voltage is lower than a third voltage that is lower than the second voltage.

In one embodiment, the second bypass circuit may provide hysteresis to the third voltage. Accordingly, when the input voltage fluctuates near the third voltage, it is possible to prevent the second portion from being lit or unlit.

In one embodiment, the LED string may include three LEDs and each of the first portion to the third portion may include one LED.

In one embodiment, the LED string may include four LEDs. The first portion may include two LEDs. The second portion may include one LED.

In one embodiment, the LED string may include four LEDs. The first portion may include one LED. The second portion may include two LEDs.

In one embodiment, the light source module may be an LED socket.

In one embodiment, a diode for reverse connection protection provided between an input terminal of the LED driver circuit and a battery may be further provided.

In one embodiment, the LED string may be housed in one package and provided with pins for connecting the first bypass circuit and the second bypass circuit.

A lighting circuit according to one embodiment is a lighting circuit that drives an LED string that includes a plurality of light emitting diodes (LEDs) connected in series and that is divided into a first portion, a second portion, and a third portion, the lighting circuit including: an LED driver circuit that receives a power supply voltage according to a battery voltage and supplies a drive current stabilized at a target current to the LED string; a first bypass circuit that is provided in parallel to the first portion and generates a bypass current with a current amount according to the power supply voltage; and a second bypass circuit that includes a bypass switch provided in parallel to the first portion and the second portion.

A lighting circuit according to one embodiment is a lighting circuit that drives an LED string that includes a plurality of light emitting diodes (LEDs) connected in series and that is divided into a first portion, a second portion, and a third portion, the lighting circuit including: an LED driver circuit that receives a power supply voltage according to a battery voltage and supplies a drive current stabilized at a target current to the LED string; a first bypass circuit that is provided in parallel to the first portion and generates a bypass current according to the power supply voltage; and a second bypass circuit that includes a bypass switch provided in parallel to the second portion.

### EMBODIMENTS

Description will be made below regarding preferred embodiments with reference to the drawings. The same or similar components, members, and processes are denoted by the same symbols, and redundant description thereof will be omitted as appropriate. The embodiments have been described for exemplary purposes only, and are by no means intended to restrict the present disclosure and the present invention. Also, it is not necessarily essential for the present disclosure and the present invention that all the features or a combination thereof be provided as described in the embodiments.

In the present specification, “a state in which the member A is connected to the member B” includes not only a case where the member A and the member B are physically and directly connected to each other, but also a case where the member A and the member B are indirectly connected to each other via another member which does not substantially affect their electrical connection state or which does not impair a function or an effect exhibited by their coupling.

Similarly, “a state in which the member C is provided between the member A and the member B” includes not only a case where the member A and the member C, or the member B and the member C are directly connected to each other, but also a case where the members are indirectly connected to each other via another member which does not substantially affect their electrical connection state or which does not impair a function or an effect exhibited by their coupling.

In addition, in the present specification, a sign attached to an electric signal such as a voltage signal and a current signal, or a circuit element such as a resistor and a capacitor represents a voltage value, a current value, a resistance value, or a capacitance value as necessary.

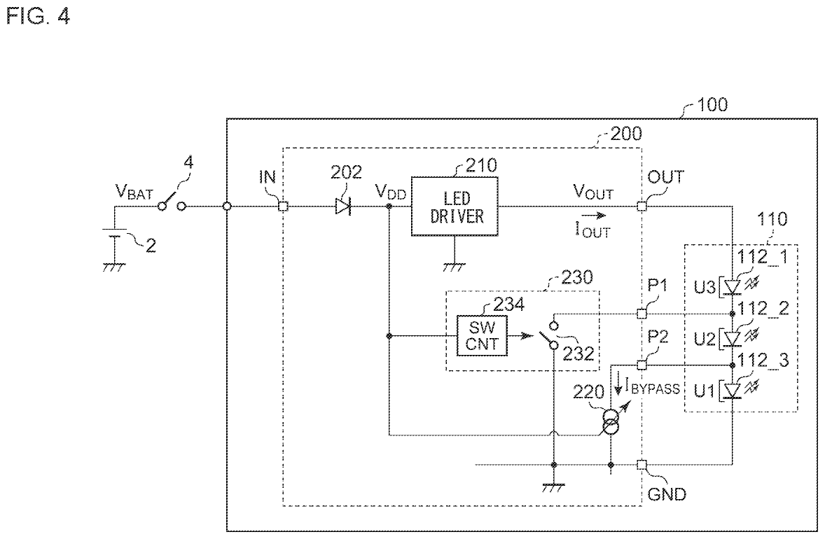

FIG. 4 is a block diagram of a light source module 100 including a lighting circuit 200 according to an embodiment. A DC voltage (referred to as a battery voltage or an input voltage) V_{BAT} from a battery 2 is supplied to the light source module 100 via a switch 4. The light source module 100 includes an LED string 110 and the lighting circuit 200. The LED string 110 includes three LEDs 112_1 to 112_3 connected in series. The LEDs 112 are white LEDs. The LED string 110 is divided into a first portion U1, a second portion U2, and a third portion U3.

The light source module 100 is a vehicle lamp in which the LED string 110 and the lighting circuit 200 are housed in one package. For example, the light source module 100 is an LED socket having a shape attachable to and detachable from a lamp body (not illustrated), similarly to a conventional automotive light bulb. Since the LED socket is a consumable, cost reduction is strongly required as well as a long life.

The lighting circuit 200 includes a diode 202 for reverse connection protection, an LED driver circuit 210, a first bypass circuit 220, and a second bypass circuit 230.

The LED driver circuit 210 receives a power supply voltage V_{DD} according to a battery voltage V_{BAT}, and supplies a drive current I_{OUT} stabilized at a target current I_{REF} to the LED string 110. The LED driver circuit 210 can include any one of (i) a constant-current linear regulator, (ii) a step-down switching converter for constant-current output, (iii) a combination of a step-down switching converter for constant-voltage output and a constant-current circuit, and (iv) a resistor. An output voltage V_{OUT} of the LED driver circuit 210 does not exceed the power supply voltage V. In this example, the power supply voltage V_{DD} is a voltage lower than the battery voltage V_{BAT} by a forward voltage Vf of the diode 202. If the diode 202 is omitted, the power supply voltage V_{DD} is equal to the battery voltage V_{BAT}.

The first bypass circuit 220 is provided in parallel to the first portion U1 of the LED string 110. The first bypass circuit 220 sinks a bypass current I_{BYPASS} having a current amount according to the power supply voltage V_{DD}. Specifically, the bypass current I_{BYPASS} has a negative correlation with the power supply voltage V.

The second bypass circuit 230 includes a bypass switch 232 and a switch control circuit 234. The bypass switch 232 is provided in parallel to a series connection portion of the first portion U1 and the second portion U2. The switch control circuit 234 controls on and off of the bypass switch 232 according to the power supply voltage V.

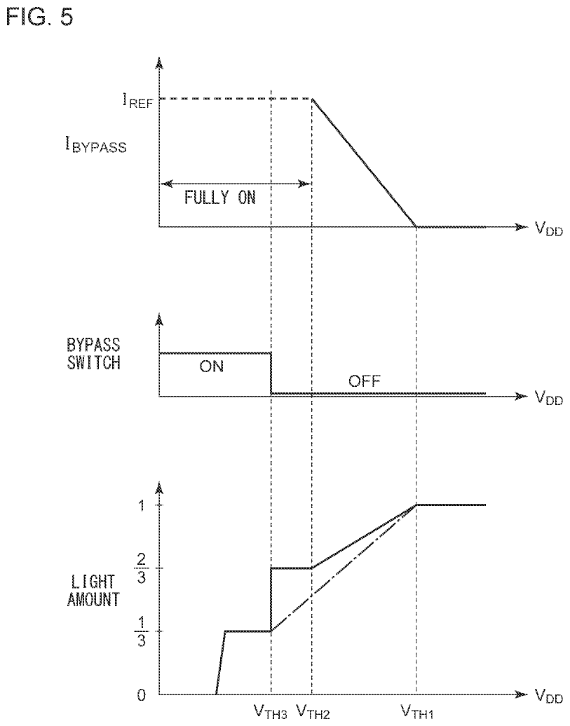

The basic configuration of the light source module 100 has been described above. Next, its operation will be described. FIG. 5 is a diagram for explaining an operation of the light source module 100 of FIG. 4. The bypass current I_{BYPASS} generated by the first bypass circuit 220 is 0 in a range where the power supply voltage V_{DD} is higher than a first voltage V_{TH1}, starts to increase when the power supply voltage V_{DD} is lower than the first voltage V_{TH1}, and increases to the target current I_{REF} of the output current I_{LED} of the LED driver circuit 210 when the power supply voltage V_{DD} decreases to a second voltage V_{TH2}. In the region of V_{DD}<V_{TH2}, a transistor of an output stage of the first bypass circuit 220 is preferably fully on.

The second bypass circuit 230 turns on the bypass switch 232 in a range where the power supply voltage V_{DD} is lower than a third voltage V_{TH3} that is lower than the second voltage V_{TH2}.

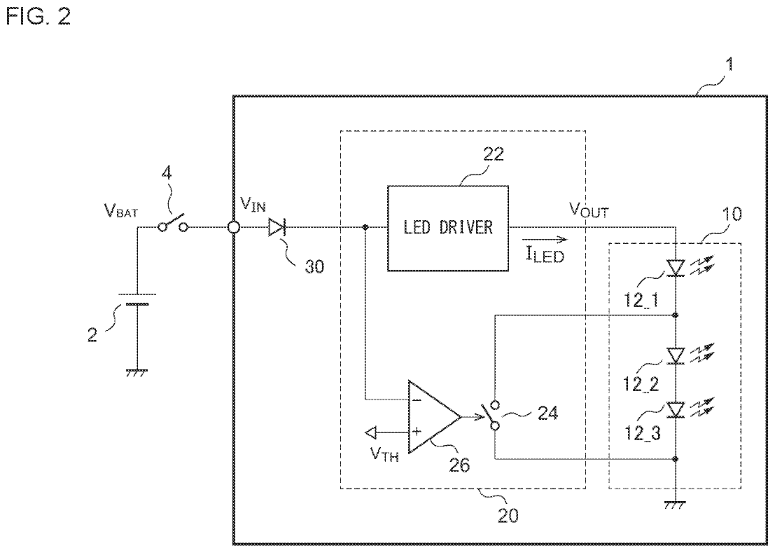

The third row of FIG. 5 illustrates the light amount of the entire LED string 110. In the range of V_{TH1}<V_{DD}, all the LEDs 112 are lit. The light amount in FIG. 5 is normalized with the light amount when all the LEDs 112 are lit as 1. Note that an alternate long and short dash line indicates the light amount in the configuration of FIG. 2 for comparison.

In the range of V_{TH2}<V_{DD}<V_{TH1}, the second portion U2 and the third portion U3 emit light with a normal light amount, while the light amount of the first portion U1 decreases as the power supply voltage V_{DD} decreases. Therefore, the light amount of the LED string 110 changes between ⅔ and 1.

In the range of V_{TH3}<V_{DD}<V_{TH2}, no change occurs in a circuit operation, and the light amount is maintained at ⅔.

In the range of V_{DD}<V_{TH3}, since the bypass switch 232 is turned on, the first portion U1 and the second portion U2 are bypassed, and only the third portion U3 is lit. The light amount at this time is ⅓.

The operation of the light source module 100 has been described above. Next, its advantages will be described.

As can be seen from the comparison between the solid line and the alternate long and short dash line of the light amount illustrated in FIG. 5, with the light source module 100 of FIG. 4, a large light amount can be obtained as compared with the conventional technique. In addition, in the range of V_{TH2}<V_{DD}, the light amount decreases only to ⅔, and the inclination of the light amount change decreases, so that flickering can be reduced as compared with the conventional technique.

Note that when V_{DD} is nearly equal to V_{TH3}, the light amount rapidly decreases, but this voltage region is lower than the actual use voltage range (for example, 9 V or more), so that occurrence of flickering does not cause a problem.

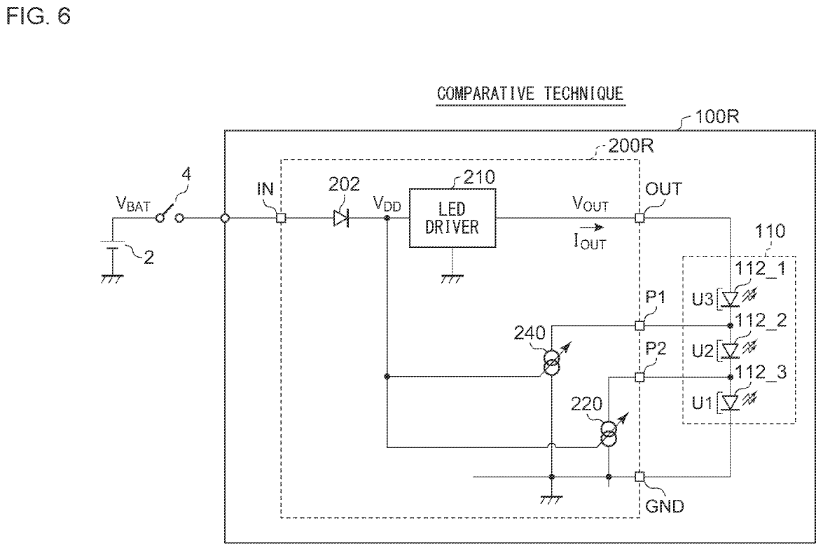

Another advantage of the light source module 100 is clarified by comparison with a comparative technique. FIG. 6 is a circuit diagram of a light source module 100R according to a comparative technique; The light source module 100R according to the comparative technique includes a bypass circuit 240 instead of the second bypass circuit 230. The bypass circuit 240 operates as a variable current source similarly to the first bypass circuit 220, and is configured to sink a bypass current according to the power supply voltage V.

Regarding the power consumption of the bypass circuit 240, the bypass circuit 240 consumes power of P=I_{BYPASS}×(Vf×2) in the active state. Therefore, an output transistor of the bypass circuit 240 needs to use an element having a size that allows the power P, which causes an increase in cost.

The power consumption of the second bypass circuit 230 of FIG. 2 will be examined. The bypass switch 232 operates in two states of on and off. In the on state in which the current flows through the bypass switch 232, the drain-source voltage (collector-emitter voltage) is much smaller than 2×Vf. Therefore, in the light source module 100 in FIG. 2, the bypass switch 232 can be structured with a small element having a small allowable power, which can reduce the cost.

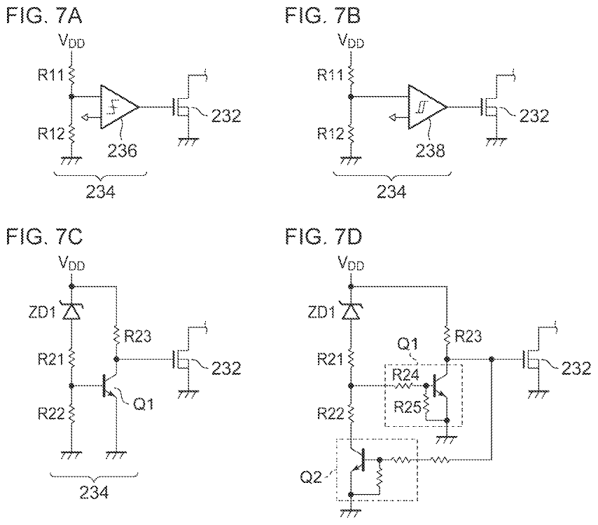

Next, a configuration example of the second bypass circuit 230 will be described. FIGS. 7A to 7D are circuit diagrams illustrating configuration examples of the second bypass circuit 230. The switch control circuit 234 of FIG. 7A includes resistors R11 and R12 and a comparator 236. The power supply voltage V_{DD} is divided by the resistors R11 and R12. The comparator 236 compares the divided power supply voltage with a threshold voltage corresponding to the third voltage V_{TX3}.

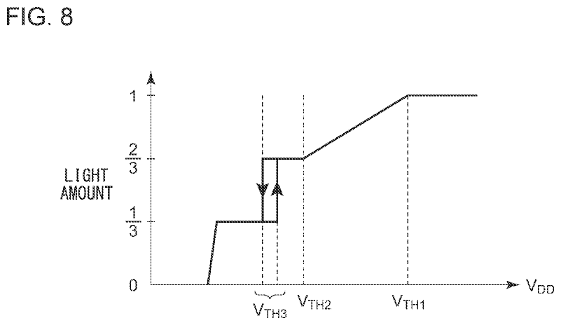

The switch control circuit 234 of FIG. 7B includes a hysteresis comparator 238 and is configured to provide hysteresis to the third voltage V_{TH3}. FIG. 8 is a diagram for explaining an operation when the third voltage V_{TH3} has hysteresis. By providing hysteresis to the third voltage V_{TH3}, the bypass switch 232 is repeatedly turned on and off when the power supply voltage V_{DD} remains near the third voltage V_{TH3}, which can prevent the LED string 110 from flickering.

The description returns to FIG. 7C. A switch control circuit 234 includes resistors R21 to R23, a Zener diode ZD1, and a transistor Q1. In a state in which the power supply voltage V_{DD} exceeds a Zener voltage Vz, the Zener diode ZD1 is conducted in the reverse direction, and the transistor Q1 is turned on, so that a gate of a bypass switch 232 is turned low and the bypass switch 232 is turned off. When the power supply voltage V_{DD} becomes lower than the Zener voltage Vz, the Zener diode ZD1 is not conducted, and the transistor Q1 is turned off. Therefore, the gate of the bypass switch 232 becomes high, and the bypass switch 232 is turned on.

FIG. 7D illustrates a configuration in which the switch control circuit 234 of FIG. 7C has hysteresis. Transistors Q1 and Q2 are transistors with resistors. The on and off states of the transistor Q2 are linked with the on and off states of the bypass switch 232. As a result, a division ratio of a resistance voltage-dividing circuit formed by resistors R21, R22, R24, and R25 changes, and hysteresis is introduced.

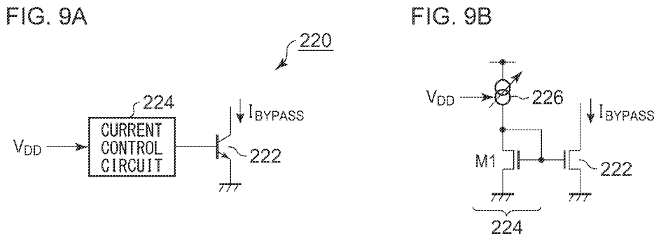

FIGS. 9A and 9B are circuit diagrams illustrating a configuration example of the first bypass circuit 220. The first bypass circuit 220 of FIG. 9A includes an output transistor 222 and a current control circuit 224. The output transistor 222 may be a bipolar transistor or a field effect transistor (FET). The current control circuit 224 controls a base current (gate voltage) of the output transistor 222 according to the power supply voltage V_{DD}, and adjusts the bypass current I_{BYPASS}.

In the first bypass circuit 220 of FIG. 9B, the current control circuit 224 includes a transistor M1 and a variable current source 226. The transistor M1 configures a current mirror circuit with the output transistor 222. The variable current source 226 generates a current Iv according to the power supply voltage V_{DD} and supplies the current Iv to the transistor M1.

The embodiments are intended to be illustrative only and it will be understood by those skilled in the art that various modifications to components and processes can be made and that such modifications are also within the scope of the present invention. Hereinafter, such modifications will be described.

### First Modification Example

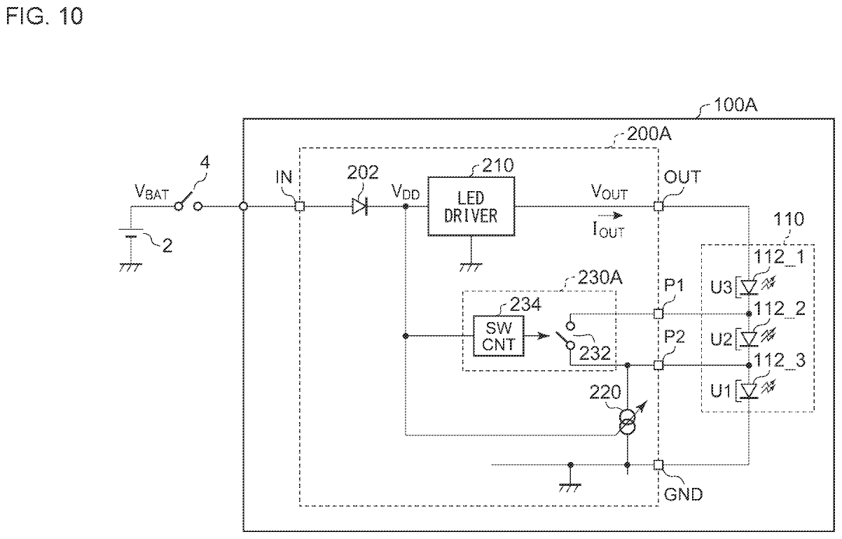

FIG. 10 is a circuit diagram of a light source module 100A according to Modification 1. The bypass switch 232 of a second bypass circuit 230A is connected in parallel to the second portion U2. The rest is the same as in FIG. 4. The same effects as those of FIG. 4 can be obtained in this modification example.

### Second Modification Example

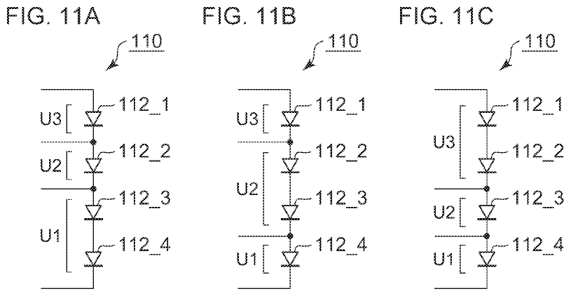

FIGS. 11A to 11C are diagrams for explaining a light source module 100B according to Modification 2. The number of LEDs 112 in the LED string 110 may be 4. In this case, as illustrated in FIGS. 11A to 11C, any one of U1 to U3 may include two LEDs, and the rest may include one LED.

### Third Modification Example

The arrangement (order) of the first portion U1 to the third portion U3 is not limited to those illustrated in FIG. 4 and FIG. 11A to 11C, and may be interchanged.

### Fourth Modification Example

In the embodiments, the LED driver circuit 210 is provided on the higher potential side than the LED string 110 to source the drive current, but the LED driver circuit 210 may be provided on the lower potential side than the LED string 110 to sink the drive current.

The embodiments are intended to be illustrative only, and it will be understood by those skilled in the art that various modifications exist in combinations of their components and processing processes and that such modifications are also included in the scope of the present disclosure or the present invention.

What is claimed is:

1. A light source module comprising:
an LED string including a plurality of light emitting diodes (LEDs) connected in series, wherein the plurality of LEDs is divided into a first portion, a second portion, and a third portion;
an LED driver circuit coupled to receive a power supply voltage according to a battery voltage and structured to supply a drive current stabilized at a target current to the LED string;
a first bypass circuit provided in parallel to the first portion and structured to generate a bypass current with a current amount according to the power supply voltage; and
a second bypass circuit including a bypass switch provided in parallel to the first portion and the second portion.

2. A light source module comprising:
an LED string including a plurality of light emitting diodes (LEDs) connected in series, wherein the plurality of LEDs is divided into a first portion, a second portion, and a third portion;
an LED driver circuit coupled to receive a power supply voltage according to a battery voltage and structured to supply a drive current stabilized at a target current to the LED string;
a first bypass circuit provided in parallel to the first portion and structured to generate a bypass current according to the power supply voltage; and
a second bypass circuit including a bypass switch provided in parallel to the second portion.

3. The light source module according to claim 1, wherein the bypass current is zero in a range where the power supply voltage is higher than a first voltage, starts to increase when the power supply voltage falls below the first voltage, and increases to the target current when the power supply voltage decreases to a second voltage; and
the second bypass circuit is structured to turn on the bypass switch in a range in which the power supply voltage is lower than a third voltage that is lower than the second voltage.

4. The light source module according to claim 2, wherein the bypass current is zero in a range where the power supply voltage is higher than a first voltage, starts to increase when the power supply voltage falls below the first voltage, and increases to the target current when the power supply voltage decreases to a second voltage; and
the second bypass circuit is structured to turn on the bypass switch in a range in which the power supply voltage is lower than a third voltage that is lower than the second voltage.

5. The light source module according to claim 3, wherein the second bypass circuit provides hysteresis to the third voltage.

6. The light source module according to claim 4, wherein the second bypass circuit provides hysteresis to the third voltage.

7. The light source module according to claim 1, wherein the LED string comprises three LEDs, and
each of the first portion to the third portion includes one LED.

8. The light source module according to claim 2, wherein the LED string comprises three LEDs, and
each of the first portion to the third portion includes one LED.

9. The light source module according to claim 1, wherein the light source module is an LED socket.

10. The light source module according to claim 2, wherein the light source module is an LED socket.

11. The light source module according to claim 1, further comprising a diode for reverse connection protection provided between an input terminal of the LED driver circuit and a battery.

12. The light source module according to claim 2, further comprising a diode for reverse connection protection provided between an input terminal of the LED driver circuit and a battery.

13. The light source module according to claim 1, wherein the LED string is housed in one package, and pins to be coupled to the first bypass circuit and the second bypass circuit is provided.

14. A lighting circuit that drives an LED string including a plurality of light emitting diodes (LEDs) connected in series, wherein the plurality of LEDs is divided into a first portion, a second portion, and a third portion, the lighting circuit comprising:
an LED driver circuit coupled to receive a power supply voltage according to a battery voltage and structured to supply a drive current stabilized at a target current to the LED string;
a first bypass circuit provided in parallel to the first portion and structured to generate a bypass current with a current amount according to the power supply voltage; and
a second bypass circuit including a bypass switch provided in parallel to the first portion and the second portion.

15. A lighting circuit that drives an LED string including a plurality of light emitting diodes (LEDs) connected in series, wherein the plurality of LEDs is divided into a first portion, a second portion, and a third portion, the lighting circuit comprising:
an LED driver circuit coupled to receive a power supply voltage according to a battery voltage and structured to supply a drive current stabilized at a target current to the LED string;
a first bypass circuit provided in parallel to the first portion and structured to generate a bypass current according to the power supply voltage; and
a second bypass circuit including a bypass switch provided in parallel to the second portion.
